(19) United States
(12) Patent Application Publication
(10) Pub. No.: US 2024/0035458 A1
(43) Pub. Date: Feb. 1, 2024

(54) Method and Apparatus for Accelerating a Vehicle in a Gravitational Field

(71) Applicants: Cristina NANIA, Miamisburg, OH (US); Ionut Adrian NANIA, Miamisburg, OH (US)

(72) Inventors: Cristina NANIA, Miamisburg, OH (US); Ionut Adrian NANIA, Miamisburg, OH (US)

(21) Appl. No.: 18/214,720

(22) Filed: Jun. 27, 2023

Related U.S. Application Data
(60) Provisional application No. 63/394,083, filed on Aug. 1, 2022.
(60) Provisional application No. 63/400,474, filed on Aug. 24, 2022.
(60) Provisional application No. 63/402,297, filed on Aug. 30, 2022.

(51) Int. Cl. B64G 1/28; B64G 1/40; B64G 1/24

(52) U.S. Cl. CPC B64G 1/28; B64G 1/40; B64G 1/242

(57) ABSTRACT

A propulsion engine and its use in a vehicle and method for space propulsion of a vehicle in a gravitational field for orbital altitude control or travel in deep space. The propulsion engine of the vehicle employs non-ejectable propellant masses that are accelerated cyclically in a selected average vectorial direction between two random and distinctive points following any random path with a mean central point, thereby generating and amplifying local gravity assist. The acceleration of the non-ejectable propellant masses causes the propulsion engine to accelerate the vehicle away from the source of the gravitational field to a tangential velocity that matches or exceeds the stable tangential velocity to maintain or raise the vehicle to a second stable orbital altitude, or continuously and locally generates gravity assist boost moving through the cosmic gravitational field lines in deep space.

### CROSS-REFERENCE TO PREVIOUS APPLICATIONS

The present application claims the benefits of U.S. Provisional Application No. 63/402,297 filed on Aug. 30, 2022. U.S. Provisional Application No. 63/400,474 filed on Aug. 24, 2022, and U.S. Provisional Application No. 63/394,083 filed on Aug. 1, 2022, the entireties of which are hereby incorporated by reference.

### FIELD OF THE INVENTION

The invention relates to methods and vehicles for air and deep space travel in cosmos, generating vectorial acceleration using the direct action of a gravitational field.

### BACKGROUND OF THE INVENTION

Our vast Universe is mostly void, with various space objects gravitating each other at great cosmic distance. Given any two celestial bodies influencing each other through their gravitation fields (any two random celestial bodies or microscopic objects will influence each other through gravity, at any distance), we can identify only two possible scenarios: 1) the objects will collide, and 2) the objects will sling-shot each other at accelerated speed. Some objects will gravitate to each other for a while and then will collide, and some of them will indeed collide directly head-on into each other; colliding has been the exception, not the rule. it will require a very narrow set of ideal conditions for a collision to occur.

The opposite is true: most of the celestial bodies will never collide. Instead, any two random particles or celestial bodies, at any location in the Universe will slingshot each other away at an accelerated speed. The Universe will expand at an accelerated rate, the distance between any two celestial bodies will increase to infinity. It is possible to calculate how much acceleration two objects (particles or celestial bodies) will impose onto each other through centrifugal force, at any distance: it is always a non-zero number. A very small number indeed for particles with mass, gigantic numbers for massive celestial bodies (galaxies or clusters of galaxies), but a permanent gradient number that works continuously in time, over eons. That number will accelerate celestial bodies away, to infinity.

We believe that the only universe that would collapse into the primordial origin, would be one with a single central gravitational point, filled with unnatural objects that could only be attracted by a central gravity point but cannot attract each other: we believe such theoretical universe does not exist. The common misunderstanding of gravity implies that the universe must necessarily collapse under the gravity pull, back into the primordial seed. And yet, the universe is not only happily expanding, but is doing so at an accelerating rate. Dark Matter and Dark Energy are constructs that have been conceived and pushed forward by others in the past, though no rational explanation of its basis in fact have been presented. To the contrary, we believe the expansion of the universe is a very natural and very direct effect of cosmic objects passing with high speeds through various gravitational fields, fully explained by the general theory of relativity, nothing more than gravity assist acceleration at a cosmic scale, with no mysterious forces acting unseen behind the scene.

Albert Einstein himself was very close to explaining Gravity through his Cosmological Constant (and later forced to retract it), except for one counterintuitive detail: gravity is not always a force of attraction. Gravity is in fact the cosmic engine generating centrifugal force (gravity assist), forcing the universe to expand at an accelerated rate: the present invention provides a way to amplify and harvest this force. The Cosmological Constant is real, and can be defined as the vectorial result of all gravitational sources in the universe as perceived in one point: we could call it in this case the Local Cosmological Coefficient.

Gravity is not the direct force repelling two objects; the centrifugal force is, through the slingshot effect of gravity. The Moon is gravitating around Earth, and a centrifugal force is strong enough to repel the Moon away from Earth. In turn, Earth gravitates around the Sun, and a separate centrifugal force is exerted on Earth and on Moon, that is strong enough to repel Earth with its Moon away from the Sun. The Moon thus has a circular movement around Earth, and a combined corkscrew/circular movement around the Sun, getting repelled away from the Sun even more by a changing centrifugal force vector between the Moon and the Sun. The speed at which the Moon travels around the Sun is much greater than the speed of the Earth around the Sun. Further, the Sun is traveling in a circular orbit as part of our Milky Way galaxy, and our galaxy travels around in space as part of clusters of galaxies and filaments of clusters of galaxies. At each step the speed at which our own moon travels through space is amplified by many orders of magnitude, reaching mind-boggling speeds and benefiting from a gigantic and unseen gravity assist amplification, something that nobody took yet into account before our discovery and out invention. It is our belief this is the basis and the true explanation for NASA's puzzling and still unexplained discovery that the drifting speed of Titan away from Saturn is about two orders of magnitude off (faster) from what NASA calculated that it should be and expected to confirm through measurements. This is the basis for developing a method of amplifying and using the Gravity Assist power through what we call Folded Acceleration.

Conventional long-distance air and space travel are achieved using vehicles that burn fuel to generate propulsion forces. In the case of long-distance air travel, a lift/propulsion force must be supplied to the aircraft/spacecraft continuously. In both air and space travel, the weight of the fuel is a substantial amount of overall vehicle weight. Thus, the combined weight of the vehicle and its fuel must be overcome to lift and propel the vehicle through the air and into space. In the case of space vehicles, the percentage of fuel to overall vehicle weight (also known as “mass fraction”) is typically in the range of 80-90%. That is, the weight of fuel on a space vehicle is 80-90% of the combined weight of the space vehicle and the fuel. This requirement for so much combustible fuel presents efficiency, cost, and safety issues.

Propellant efficiency as would be needed for a true interstellar space propulsion engine is not about the specific impulse of a propellant, or any other classical parameters. What matters for space travel is the ability of an engine to re-use a “propellant” again and again, to retrieve and re-use the same mass used to propel a vehicle, in consecutive cycles. For achieving interstellar space travel, a propulsion system is needed that can use a propellant, then retrieve and reuse the same propellant, with zero or minimal loss of propellant mass between consecutive propulsion cycles. There will be a significant amount of energy required to “throw away”, “recover”, and repeat the cycle with this re-usable propellant, but the electric energy needed can be generated efficiently and effectively aboard of a space vehicle, with existing technology. Up to now this kind of propulsion engine has not been known: understanding folded acceleration and accounting for gravity in the operation of folded acceleration propulsion engines, makes propellant “retrieval” possible, practical, and effective.

### SUMMARY OF THE INVENTION

The invention relates generally to methods and vehicles for air and deep space travel in cosmos; and more generally to a method and system for generating vectorial acceleration using the direct action of a gravitational field upon any object with mass passing through it, to provide effects that can be described as slingshot effect, gravity assist (NASA for rockets, satellites), or centrifugal acceleration that is locally generated, amplified, and harvested through cyclical acceleration between two random and distinctive points following any random path with a mean central point, without the need for common satellite maneuvers or other gravity assist maneuvers in space. Folded acceleration is defined as cyclically accelerating the same mass (non-ejectable propellant) along a linear, curved, circular or any random path, provided that the starting point is the mean central position (or point) of the mass movement, and that the propelling mass speed and destination end points are used to calculate the total generated centrifugal force.

The present invention utilizes the principle of folded acceleration delivered by a folded acceleration propulsion engine (hereinafter FAPE) to increase orbital altitude of a vehicle having a one or more, and typically a multiplicity of, propulsion units and/or propulsion engines, employing a non-ejectable propellant, to raise the altitude of the vehicle as it travels in a stable orbit around a planet, or in space in the gravitational fields of a multiplicity of celestial bodies.

In various embodiments, a source of power to drive the mass bodies and/or generate mechanical, magnetic or electromagnetic acceleration is typically selected to provide an efficient conversion of energy generated to centrifugal force. Non-limiting examples of power sources can include nuclear, thermal, acoustic, electromagnetic, solar and other optical, and chemical sources.

A folded acceleration engine will not only accelerate a vehicle in space, but the resulting local and directional acceleration will provide a direct and natural measure of the Local Cosmological Coefficient in that specific point of universe. For the folded acceleration engine to work there must be a gravitational field, and the resulting acceleration will correlate directly with the directional strength of said gravitational field, which reveals the need to set the engine orientation in order to maximize efficiency in a specific direction or selectively cancel (in limited scenarios) or minimize (always possible) the effect of one specific gravitational vector. Mapping the 3D gravity field around a vehicle (the directional and Local Cosmological Coefficient in the whole 3D space) will be an important tool for space navigation, and the folded acceleration engine naturally generates acceleration directly proportional with the local and directional gravity field vector. The vectorial result of all gravitational sources in the universe can be perceived at any point, and measured at that point as a by-product of the resulting acceleration experienced by a folded acceleration engine operating at such point.

An aspect of the present invention provides a method and system for controlled acceleration of a vehicle in a gravitational field, for satellite altitude control and for space travel using a propulsion engine that exerts folded acceleration. The process of folded acceleration uses the cyclical acceleration of an engine mass, or plurality of engine masses of a propulsion engine, in a selected vectorial direction, which generates extra centrifugal acceleration (slingshot acceleration), which in turn causes the mass(es) to accelerate away from the gravitation source.

For a vehicle in a stable orbit, a folded acceleration propulsion engine can use a non-ejectable mass (with the role of “propellant”) to raise the orbital altitude of the vehicle without using any real electable propellant. Folded acceleration does not require that acceleration and speed are constant in an orbit. A change in direction left-right, backward/forward, or any cyclical random direction produces extra centrifugal force. The average acceleration and speed of the total equivalent mass of the vehicle, including the non-ejectable mass, should at least match (to maintain), and preferably exceed (to accelerate), the minimum acceleration and speed required to propel the vehicle through the deep space or to maneuver a satellite between various stable or unstable orbits.

Another aspect of the present invention is a folded acceleration propulsion engine that uses the gravitational force of the Earth or other heavenly body to propel a vehicle away from the gravity vector through Amplified Gravitational Slingshot Effect, or Amplified Gravity Assist. The propelling action does not necessarily have to be around a planet or star and complete full or partial orbital cycles, but can manifest over any length of interstellar space where a gravitational field is present, in any direction. The Gravity Assist is much easier to observe directly when it is exercised over long distances, but it is manifesting identically over any non-zero distance and has the same end effect as if is exercised continuously with short, folded acceleration cycles over microscopic distances (accelerating mass using cyclical directional microwave radiation for example). If an object does not move straight to the gravity well and has enough speed (most everything in the universe moves very fast), either by intrinsic physical state or by natural or artificially Folded Acceleration (see Oumuamua), then the object will be sling-shot away. Is Oumuamua some alien technology? Given the direction and speed of Oumuamua when leaving our solar system, only another natural source of Gravity Assist would accelerate Oumuamua while leaving our solar system (for example near-by black holes or our own Milky Way galaxy), if that exterior gravity source is powerful enough to overcome the attraction of our own solar system on that vectorial path and to provide that boost in acceleration that NASA measured. Otherwise, if there are no known natural materials and natural physics to act like a local Folded Acceleration engine that can greatly amplify and locally harvest that extra Gravity Assist effect, then yes, Oumuarnua could be alien technology.

The present invention also provides a folded acceleration propulsion engine, system and method for a vehicle that propels a spacecraft through the deep space or raises the orbital altitude of the vehicle around a planetary or celestial body exerting a gravitation force, by including one element or a plurality of propulsion elements having mass moving in a series of changing sign, for example oppositely-directed, acceleration cycles. In some embodiments, the plurality of propulsion elements having mass reciprocate in a series of oppositely-directed accelerations (accelerating, decelerating, accelerating in reverse and in the opposite direction, decelerating, and repeating cycle) along a linear pathway.

The present invention allows a vehicle that includes a folded acceleration propulsion system to travel through the universe or a rocket to reach low Earth orbit by having a much lower propellant mass fraction, higher specific impulse, a higher thrust to weight ratio than a vehicle that relies entirely on fuel or an ejectable propellant to both produce lift to reach low Earth orbit and to increase or raise orbital altitude. Also, the same invention allows an existing satellite on a stable orbit to gain altitude on demand without wasting any propellant, for example the international Space Station could maintain and/or increase orbit without the need to re-supply with propellant/fuel, with no need to decommission the whole station when the supply runs out (as it is the case today with NASA's plan to decommission ISS). The same is the case with NASA's James Webb Space Telescope, a 10 billion investment that was recently place in the Second Lagrangian point, orbit 1.5 million kilometers (1 million miles) away from the Earth. Sadly, it was already permanently damaged by micrometeorites, without repairing or servicing options. Our invention could provide immediately a very cost-effective spacecraft with a crew capable to reach the telescope and fix it, with minimal investments, using existing spacecraft retrofitted with a folded acceleration engine.

In various embodiments, a folded acceleration propulsion system comprises at least one, and preferably a plurality of, and more preferably a multitude, of propulsion units, each propulsion unit including a mass body, where the plurality of mass bodies of the plurality of propulsion units are positioned and configured for collective movement, including velocity and acceleration. In some embodiments, a propulsion engine comprises a pair of propulsion units, each propulsion unit including a mass body disposed and configured for movement along a common axis, and configured collectively to accelerate and deaccelerate equally and oppositely along the axis with zero change in momentum. The movement preferably is perpendicular to a force of gravity on the planetary body for maximum efficiency. In other embodiments, two, three or more propulsion units can be used in a propulsion engine disposed for movement within a common axle, common plane, or the whole 3D space around (the full 4π steradians solid angle), configured collectively to cyclically accelerate and deaccelerate equally and oppositely along the axis or axis pairs in order to minimize unwanted stress and vibrations.

In one embodiment, the present invention provides a method <1> for space propulsion of a vehicle in a gravitational field, useful for vehicle (satellite) altitude control or space travel of a vehicle (spaceship) in deep space, comprising the steps of: (i) providing a vehicle including a propulsion engine comprising one or more non-ejectable propellant masses, the vehicle having a total mass including the one or more non-ejectable propellant masses, (ii) placing the vehicle in a stable orbital altitude at a stable tangential velocity or placing the vehicle in a controlled trajectory is space, (iii) accelerating the one or more propellant masses cyclically in a selected average vectorial direction through Folded Acceleration between two random and distinctive points following any random path with a mean central point, which generates and amplifies local gravity assist and allows for harvesting that locally generated extra gravity assist boost, sliding upwards on the gravity well field lines, and causes the propulsion engine to accelerate the vehicle (satellite) away from the source of the gravitational field to a tangential velocity that matches the stable tangential velocity to maintain the vehicle in the stable orbital altitude, or exceeds the stable tangential velocity to raise the vehicle to a second stable orbital altitude, or continuously and locally generate gravity assist boost to the vehicle (spaceship) moving through the cosmic gravitational field lines in deep space, or pushing away from and upward against gravity on the gravity well field lines, where the “centrifugal forces” and “gravity assist” are a limiting subset of this physical concept.

In another embodiment, the present invention provides a method <2> for adjusting the orbital altitude of a vehicle in a gravitational field, useful for vehicle altitude control, comprising the steps of: (i) providing a vehicle including a propulsion engine comprising one or more non-ejectable propellant masses, the vehicle having a total mass including the one or more non-ejectable propellant masses, (ii) placing the vehicle in a stable orbital altitude at a stable tangential velocity, (iii) accelerating the one or more propellant masses cyclically in a selected vectorial direction, which generates a centrifugal acceleration, and causes the propulsion engine to accelerate the vehicle away from the source of the gravitational field to a tangential velocity that matches the stable tangential velocity to maintain the vehicle in the stable orbital altitude, or exceeds the stable tangential velocity to raise the vehicle to a second stable orbital altitude.

The method <1> or method <2> can further any one or more of the following features: (a) the propulsion engine comprises two or more propulsion units, each propulsion unit comprising one or more non-ejectable propellant masses; (b) the selected vectorial direction is along or within a common axle, a common plane, or a full 4π steradian solid angle, the two or more propulsion units configured collectively to cyclically accelerate and deaccelerate equally and oppositely to avoid vibration upon the propulsion engine and the vehicle; (c) one or more non-ejectable propellant masses reciprocate along a linear pathway; (d) the one or more non-ejectable propellant masses can comprise a mass selected from the group consisting of gaseous, liquid, plasma, solid and quantum particles, and a combination thereof; (e) wherein the propulsion engine includes one or more motion and force generating elements to accelerate the one or more non-ejectable propellant masses; (f) wherein the propelling forces includes a non-ejectable propulsion means selected from the group consisting of an electromagnetic, an electromechanical, a mechanical propulsion system, and a combination thereof; (g) each of the one or more non-ejectable propellant masses rotates around an axis; (h) the axis of rotation of the one or more non-ejectable propellant masses do not pass through the center of mass of the vehicle; (i) the one or more non-ejectable propellant masses can comprise a mass selected from the group consisting of gaseous, liquid, plasma, solid and quantum particles, and a combination thereof; (j) the propulsion engine includes one or more motion and force generating elements to accelerate the one or more non-ejectable propellant masses; and (k) wherein the propelling forces includes a non-ejectable propulsion means selected from the group consisting of an electromagnetic, an electromechanical, a mechanical propulsion system, and a combination thereof.

In various embodiments, non-ejectable propellant can comprise a mass in any state, the mass state selected from the group consisting of gaseous, liquid, plasma, solid and quantum particles, and the propulsion system includes a means for to physically control and constrain that mass to move cyclically between two or more different locations, and can include linear movement and/or rotational movement.

In various embodiments, a folded acceleration propulsion system can utilize the motion and forces associated with mass elements to accelerate the vehicle that employs the folded acceleration propulsion system. When the vehicle is positioned such that the propulsion system's motion is combined with the Gravity Assist generated by a cosmic body (e.g., Earth, Mars, galaxy, clusters of galaxies, black holes, etc.), the vehicle becomes an efficient long-distance space vehicle having minimal or no ejectable propellant requirements.

In various embodiments, the overall shape and size of the vehicle could approximate or mimic the shape/size defined by a vehicle's multiple propulsion systems of different types. The vehicle could also incorporate a variety of other known aerodynamic materials and structures/systems (e.g., aerodynamic shaping, control surfaces, thrusters, etc.) without departing from the scope of the present invention.

A method and system for adjusting the orbital altitude of a vehicle in a gravitational field, is useful for vehicle altitude control. with immediate use for deep space travel, deep space exploration, defense, heavy industry in space, transport of materials and supplies for terraforming and establishing habitable bases on celestial bodies, altitude correction for satellite applications, and maintaining geostationary satellites in low Earth orbit at much lower distance from to the Earth surface that is possible today. The method steps provide a vehicle including a propulsion engine comprising one or more non-ejectable propellant masses, the vehicle having a total mass including the one or more non-ejectable propellant masses, and placing the vehicle in a stable orbital altitude at a tangential velocity accelerating and crossing gravitational field lines by generating and harvesting extra local centrifugal force (amplified gravitational slingshot effect, or amplified gravity assist) in space through Folded Acceleration in a gravitational field. The one or more propellant masses are accelerated cyclically in a selected vectorial direction between two random and distinctive points following any random path with a mean central point (defined as Folded Acceleration), to generate a centrifugal acceleration to push against gravity by accelerating and crossing gravity field lines, generating/amplifying and harvesting the resulting extra local centrifugal force. The extra centrifugal force locally generated, amplified, and harvested causes the propulsion engine to accelerate the vehicle away from the source of the gravitational field, to push against gravity and climb upward on the gravity well ladder to an average acceleration and tangential velocity that at least matches or exceeds the minimum acceleration and speed required to maintain the vehicle in the stable orbital altitude allowing for unrestricted travel through deep space anywhere in the Universe where a gravitational field is present.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings.

FIG. 1 illustrates a propulsion unit in a first movement state, including a mass body and elements for providing movement and force to the mass body.

FIG. 2 illustrates the mass body of the propulsion unit of FIG. 1, in a second movement state.

FIG. 3 illustrates a propulsion engine including a pair of coaxial and opposed propulsion units in a first movement state.

FIG. 4 illustrates the propulsion engine of FIG. 3 in a second movement state.

FIG. 5 illustrates an aeronautical vehicle having a folded acceleration propulsion system that includes several propulsion units in a first movement state.

FIG. 6 illustrates the aeronautical vehicle of FIG. 5 with the several propulsion units in a second movement state.

FIG. 7 illustrates another embodiment of an aeronautical vehicle having a folded acceleration propulsion system that includes numerous propulsion units.

FIG. 8 is an exploded view of a selected portion of FIG. 7.

FIG. 9 illustrates another embodiment of a propulsion unit, illustrated as a solenoid propulsion unit with a mass plunger in a first movement state.

FIG. 10 illustrates the mass plunger of the solenoid propulsion unit of FIG. 9, in a second movement state.

FIG. 11 illustrates an aeronautical vehicle having a folded acceleration propulsion system that includes numerous solenoid propulsion units.

FIG. 12 illustrates another embodiment of an aeronautical vehicle having a folded acceleration propulsion system that employs rotational propulsion units.

FIG. 13 illustrates a rotational propulsion unit of the aeronautical vehicle of FIG. 12.

FIG. 14 illustrates the positioning and the rotational patterns of the four rotational propulsion of the aeronautical vehicle of FIG. 12.

FIG. 15 illustrates a folded acceleration propulsion engine in a stable orbit around a planet at an altitude above the planet and in an initial direction.

FIG. 16 illustrates the folded acceleration propulsion engine of FIG. 15 after releasing an amount of propellant on the right side that adds a velocity component in the left direction.

FIG. 17 illustrates the folded acceleration propulsion engine of FIG. 16 after releasing an amount of propellant on the left side that adds a velocity component in the right direction.

FIG. 18 illustrates the velocity vectors of the folded acceleration propulsion engine of FIG. 15 along its initial direction vector.

FIG. 19 illustrates the velocity vectors of the folded acceleration propulsion engine of FIG. 18, after releasing the propellant on the right side that adds a velocity component in the left direction to a direction vector to the left of the initial direction vector.

FIGS. 20 and 21 illustrate the velocity vectors of the folded acceleration propulsion engine of FIG. 19, after releasing first and second portions of the propellant, respectively, on the left side, the first portion of the propellant adding a first velocity component in the right direction to return the folded acceleration propulsion engine to its initial direction vector, and the second portion of the propellant adding a second velocity component in the right direction to a direction vector to the right of the initial direction vector.

FIG. 22 illustrates the velocity vectors of the folded acceleration propulsion engine shown in FIG. 21 after a first portion of a propellant on the right side that adds a velocity component in the left direction to return the folded acceleration propulsion engine to its initial direction vector.

FIG. 23 illustrates the folded acceleration propulsion engine after a series propellant releases alternating on the right side and the left side, resulting in an increase in altitude above the planet.

FIG. 24 illustrates a gravity well ladder and its effect on a folded acceleration propulsion engine in deep space.

FIG. 25 illustrates how a folded acceleration propulsion engine moves upward on the gravity well ladder of FIG. 24.

### DETAILED DESCRIPTION OF THE INVENTION

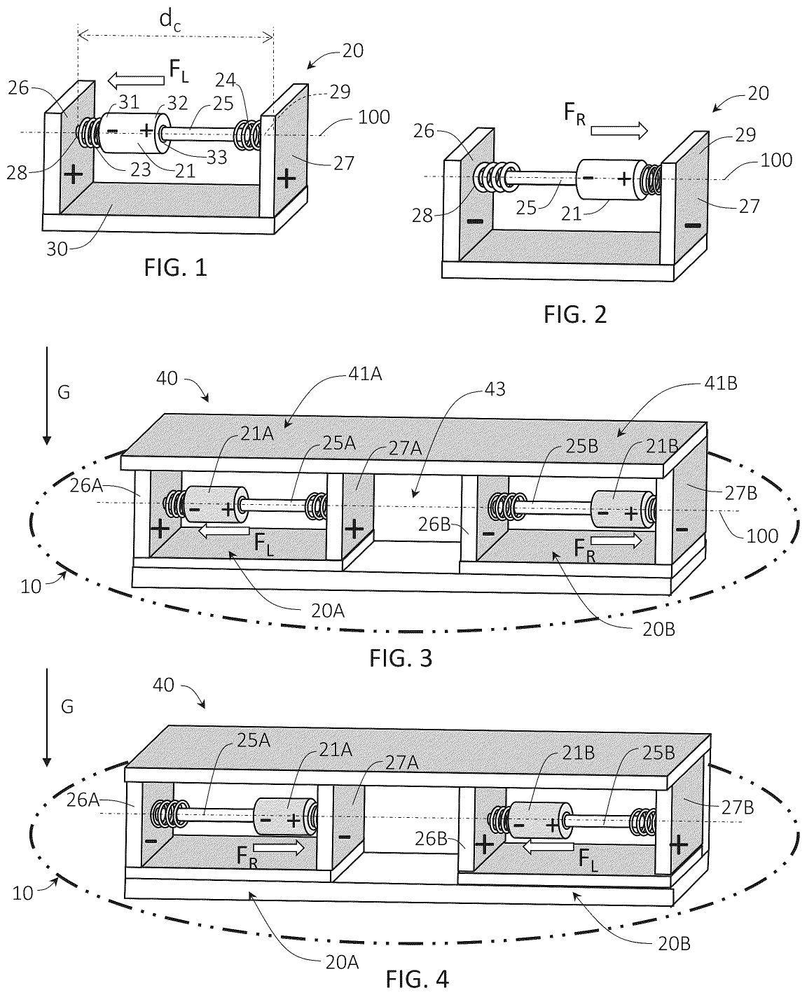

FIGS. 1 and 2 illustrate the motion and force generating elements associated with a folded acceleration propulsion system. FIG. 1 is a perspective view of a basic embodiment of a propulsion unit 20 that can be one of a multiplicity of propulsion units forming a possible version of a folded acceleration propulsion system (FAPS). Controlling the folded acceleration direction in 3D space will provide somehow a limited way to select the directional celestial body required to favor the acceleration in a specific direction, where the main thrust vector is mostly against the main gravity field lines, especially with a multitude of celestial bodies around at various distances. The propulsion unit 20 includes a moveable mass body 21 that can move reciprocally along an axle 25 between a first end 28 and an opposed second end 29. The first and second ends 28,29 of the axle 25 are secured to opposed fixed structures 26,27, illustrated as walls, that are fixed dimensionally from one another by a structure, illustrated as a base 30. The mass body 21 has a symmetrical shape about an axis 100 that extends through the axle 25, with an axial bore 33 through mass body 21 disposed coaxially about the axis 100. The axle 25 extends through the bore 33 in the mass body 21 without contacting the axle 25, and the mass body 21 moves frictionlessly along the axle 25 or without any axle at all, such as by magnetic/electromagnetic containment and electromagnetic acceleration.

Typically, the mass body is a high-density material, and is typically a dense metal such as iron or steel, though other materials include ceramics, polymers, and other non-flowable materials, or any other gas, liquid, plasma, or sub-atomic particles in a confined space.

The mass body 21 reciprocates along the axis around the axle 25 between the two opposite ends, left (first) end 28 and right (second) 29, through a multiplicity of cycles, starting at a non-moving state at a far-most left position proximate the left end 28, then accelerating under a propelling force F₁ from left end 28 toward the opposite right end 29, deaccelerating to a non-moving state at a far-most right position proximate the right end 29, then accelerating under a propelling force F₂ from right end 29 toward left end 28, and deaccelerating to the non-moving state at the far-most left position, to complete one left-and right cycle and to initiate the next left-and-right cycle.

The propelling forces F_{L} and F_{R} can be generated by any non-ejectable propulsion means, and including but not limited to an electromagnetic, or electromechanical, or mechanical propulsion system. In the illustrated embodiment, a basic electromechanical solenoid propulsion system is employed. In some embodiments, the propulsion means can include hydraulic and pressurized gas systems. In other embodiments, a mass body can be moved in a mostly linear motion via electromagnetic or microwave energy or an electric motor with an eccentric drive.

In various embodiments, the propulsion unit 20 includes a means for exerting a positive electromagnetic force alternatingly at opposed ferromagnetic sites applied by known means at the opposed fixed walls 26,27. The mass body 21 comprises magnetic properties, and can exert a negative (−) magnetic force charge at a first (left) end 31 of the mass body 21, and a positive (+) magnetic force charge at a second (right) end 32 of the mass body 21, axially opposite the first end 31. A non-limiting example of a device to generate alternating position magnetic and negative magnetic force charges is an electrical solenoid. The magnetic properties can be permanent magnetic properties of a material portion of the first and second ends of the mass body 21.

To aid in effecting deacceleration of the mass body 21 as it arrives at each of the left position and the right position, the propulsion unit 20 includes a pair of a resilient elements, each element illustrated as a helical resilient spring 23,24, positioned along the axle 25 at opposed left and right positions proximate the opposed fixed walls 26,27.

As illustrated in FIG. 1, a positive (+) magnetic force charge has been applied to both the first (left) fixed wall 26 and the second (right) fixed wall 27, which had moved the mass body 21 toward the first (left) wall 26 as a result of simultaneously attracting the negative-magnetic first end 31 of the mass body 21 and repelling the positively-magnetic second end 32 of the mass body 21, to the left axially toward the left wall 26. The movement of the mass body 21 to the left end 28 then contacts the left resilient spring 23, and the momentum of the mass body 21 then compresses, and is absorbed in part by, the left resilient spring 23, thereby exerting a portion of a force F_{L} toward the left fixed wall 26.

As the mass body 21 is approaching the left position 2 or comes into contact with the left spring 23, the magnetic force applied to the first (left) fixed wall 26 and the second (right) fixed wall 27 is switched to a negative (−) force, which causes the negatively-magnetic first end 31 of the mass body 21 to be repelled from the left wall 26, and the positively-magnetic second end 32 of the mass body 21 to be attracted to toward the right wall 27, as shown in FIG. 2. The magnetic force also generates a change in the momentum of the bass body 21 and a portion of the force toward the left fixed wall 26. The magnetic force change can be timed and synchronized with the movement of the mass body 21 to minimize the impact of the mass body 21 against the resilient element 23, and to minimize the power input required to move the mass body. The movement of the mass body 21 to the right end 29 of the axle 25 then contacts the right resilient spring 24, and the momentum of the mass body 21 compresses, and is absorbed in part by, the right resilient spring 24, thereby exerting a force FR against the right fixed wall 27. When the magnetic force applied is again switched to a positive (+) charge, as shown again in FIG. 1, the change is momentum of the mass body 21 contributes a portion of a force F_{R} toward the tight fixed wall 26.

The magnetic forces on both the first and second fixed walls 26,27 are alternated between positive and negative at a cycle frequency (a left-and-tight cycle being one change from a positive to a negative polarity, and back to a positive polarity). Each left-and-right cycle causes the mass body 21 to accelerate linearly in opposite directions along the axle 25, between the first and second positions 28,29 proximate the first and second fixed walls 26,27, resulting in left-and-right cycles of acceleration and deacceleration of the mass body 21 and an average linear velocity in each opposite direction between the first and second ends separated by a half-cycle distance d_{C}.

FIG. 3 shows an embodiment of a propulsion engine 40 comprising a pair of propulsion units 20A and 20B, positioned with the respective axles 25A,25B disposed coaxially about the axis 100, and fixed dimensionally from one another by a containment structure 34. The containment structure 34 includes a left containment chamber 41A that contains a left propulsion unit 20A and a right containment chamber 41B that contains a right propulsion unit 20B. The left and right containment chambers 41A,41B can be configured to maintain evacuated or vacuum spaces that envelope the propulsion units 20A and 20B. Operation of the propulsion units 20A and 20B includes exerting opposite, alternating the polarity of the magnetic forces onto the respective first and second fixed walls. In FIG. 4, a positive (+) magnetic force is applied to the first and second fixed walls 26A,27A of first propulsion unit 20A, while a negative (−) magnetic force is applied to the first and second fixed walls 26B,27B of second propulsion unit 20B. In FIG. 3, the magnetic charge is alternated, with a negative (−) magnetic force being applied to the first and second fixed walls 26A,27A of first propulsion unit 20A, while a positive (+) magnetic force is applied to the first and second fixed walls 26B,27B of second propulsion unit 20B. The coaxial alignment of the axles 25A,25B results in equal and opposite outwardly-directed forces F_{L} and F_{R} in FIG. 3, and equal and opposite inwardly-directed forces F_{R} and F_{L} in FIG. 4. The rapid, opposite and repeated left-and-right cycles of the pair of propulsion units 20A and 20B eliminates any net forces the other upon the containment structure 34, to provide folded acceleration avoiding vibration upon the propulsion engine 40.

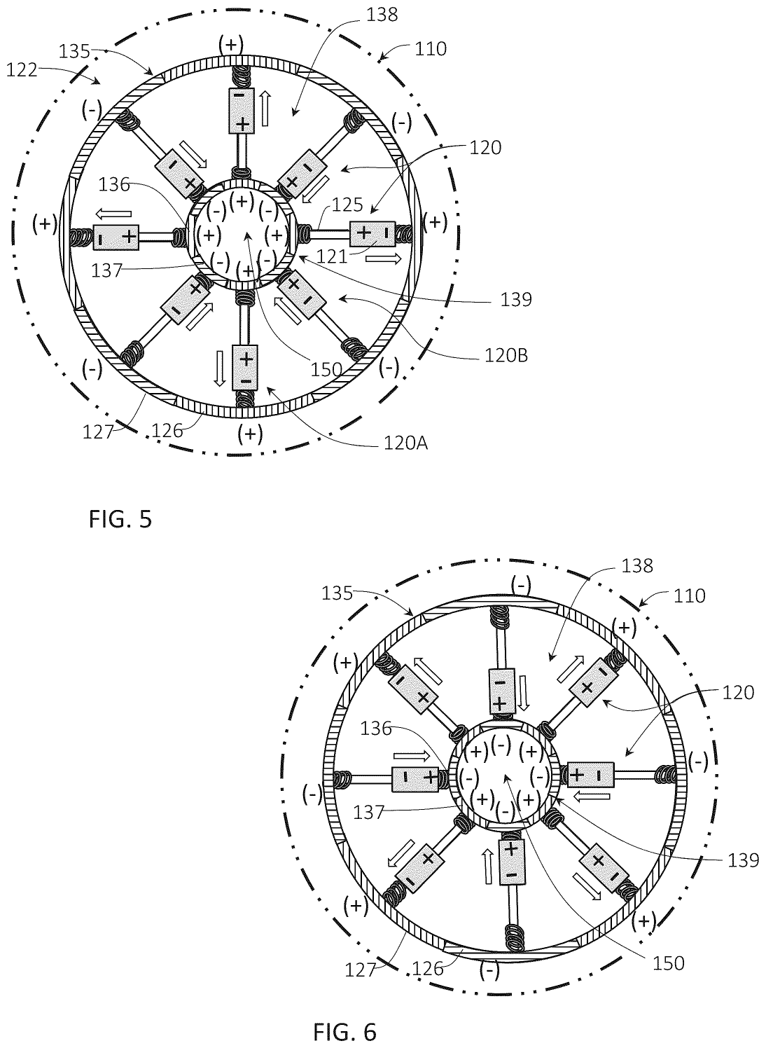

FIG. 5 is a plan view of a vehicle 110, indicated generally by the dashed circular line, that includes a folded acceleration propulsion system (FAPS) 122 comprising an engine chamber 138 and a plurality of propulsion units 120, as described above. The vehicle 110 also includes a cabin space 150.

Propulsion units 120, with respect to their respective axles 25 and the linear direction of the movement of the mass body 121, extend in a common plane, and have the same angular separation from one another. The magnetic orientation of the radially-distal ends of the plurality of mass bodies 121 is the same, with the negative (−) magnetic end 131 oriented radially outward and the positive (+) magnetic end 132 oriented radially inward. The FAPS 122 includes an outer chamber wall 135 and an inner chamber wall 139. The outer chamber wall 135 includes a circumferential series of magnetic segments 126 and 127 that can exert alternatingly a positive magnetic field or a negative magnetic field. The inner chamber wall 139 includes a circumferential series of magnetic segments 136 and 137 that can exert the same, alternatingly positive or negative magnetic field.

FIG. 5 shows a first portion of a movement cycle of the pair of propulsion units, where a first half of pairs of propulsion units 120A are driven radially outwardly by both the attracting positive (+) magnetic fields of magnetic segments 126 in the outer chamber wall 135 upon the negative (−) magnetic end 131 of the mass body 121, and the repelling positive (+) magnetic fields of magnetic segments 136 in the inner chamber wall 139 upon the positive magnet end 132 of the mass bodies 121, while a second half of pairs of propulsion units 120B are being driven radially inwardly by both the repelling negative (−) magnetic fields of magnetic segments 127 in the outer chamber wall 135 upon the negative magnetic end 131 of the mass body 121, and the attracting negative (−) magnetic fields of magnetic segments 137 in the inner chamber wall 139 upon the positive magnet end 132 of the mass bodies 121.

As described above, to complete the movement cycles of the pairs of propulsion units, the magnetic fields of the magnetic segments 126 and 127 in the outer chamber wall 135, and the magnetic segments 136 and 137 in the inner chamber wall 139, are switched. As shown in FIG. 6, the first half of the pairs of propulsion units 120 are then driven radially inwardly by both the repelling negative (−) magnetic fields of magnetic segments 126 in the outer chamber wall 135 upon the negative magnetic end 31 of the mass body 121, and the attracting negative (−) magnetic fields of magnetic segments 136 in the inner chamber wall 135 upon the positive (+) magnet end 132 of the of the mass bodies 121, while the second half of the pairs of propulsion units 120 are being driven radially outwardly by both the attracting positive (+) magnetic fields of magnetic segments 127 in the outer chamber wall 135 upon the negative (−) magnetic end 31 of the mass bodies 121, and the repelling positive (+) magnetic fields of magnetic segments 137 in the inner chamber wall 139 upon the positive magnet end 32 of the mass bodies 121. The left-and right cycle of each propulsion unit 120 is repeated for a multitude of cycles, at very rapid acceleration and velocity, and very short cycle times, to generate folded acceleration, as described hereinafter.

Also, an alternative and valid choice with identical efficiency and zero net vibration residue would be to push all pistons outward at the same time, and pull them inward synchronously, which can provide more efficient and, with one central pole and one external pole only), may be easier and less expensive to construct.

The symmetrical orientation of the propulsion units 120 eliminates any net vibration force of the vehicle 110 resulting from the rapid, opposite and repeated movements of the propulsion units 120A,120B, and provides centrifugal thrust through folded acceleration in a gravitational field, in a direction away from the center of gravity.

The engine chamber 138 maintains an evacuated space or vacuum about the plurality of propulsion units 120. While the illustrated embodiment shows eight (8) propulsion units 120, a significantly larger number of propulsion engines can be incorporated into the engine chamber 138. Also, there is no particular limitation in the length of the half cycle distance d_{C}, which can extend to many meters and longer with low frequency, or limited to very short travel distances with high frequency. The plurality of propulsion units 120 are oriented symmetrically, so that any force generated by the movement of a mass body 121 is offset by the movement of one or more other mass bodies 121 in the FAPS 22, thereby avoiding vibration of the FAPS 122 upon the vehicle 110.

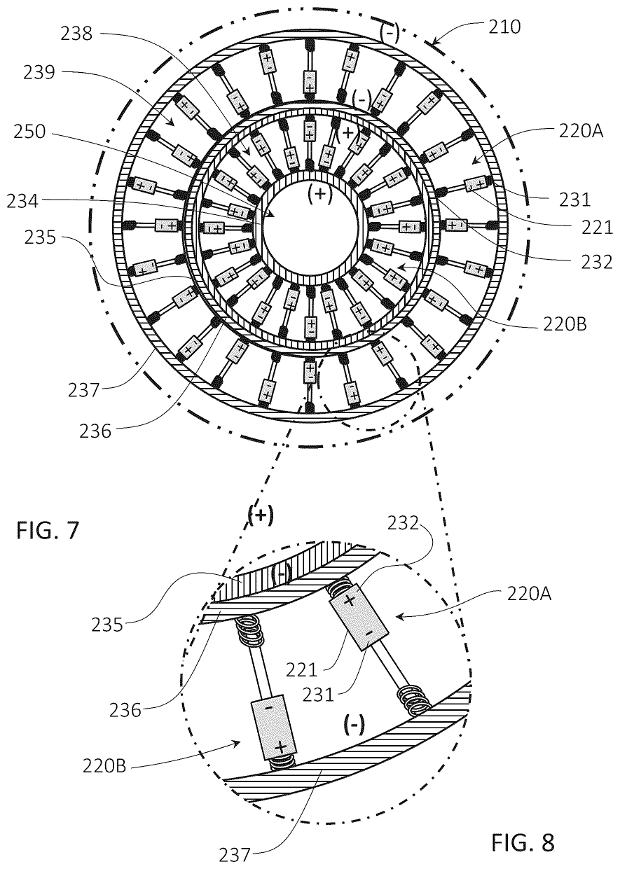

FIG. 7 illustrates another embodiment of a vehicle 210 that includes a FAPS 222 and a cabin space 250. The FAPS 222 includes two concentric engine chambers, including an inner chamber 238 and an outer chamber 239, and a plurality of propulsion units 220, as described above and illustrated in FIG. 8.

The outer chamber 239 includes an outer wall 237 and an inner wall 236, and the inner chamber 238 includes an outer wall 235 and an inner wall 234. A first plurality of propulsion units 220A are arranged circumferentially within the outer chamber 239 and align with a center point of the vehicle 210, with the magnetic orientation of the radially-distal ends 231 of the plurality of body masses 221 alternating between a negative (−) polarity and a positive (+) polarity, with the opposite end 232 of the mass bodies 221 oriented radially inward. Similarly, a second plurality of propulsion units 220B are arranged circumferentially within the inner chamber 238 and align with the centerpoint of the vehicle 210, likewise with the magnetic orientation of the radially-distal ends 231 of the plurality of body masses 221 alternating between a positive (+) polarity and a negative (−) polarity, with the opposite end 232 of the mass bodies 221 oriented radially inward.

A same magnetic force, illustrated at the start of a cycle as a negative magnetic force, is exerted onto both the outer wall 237 and inner wall 236 of the outer chamber 239, and more specifically is exerted to respective magnetic-chargeable contacts (not shown) on the outer wall 237 and the inner wall 236 of the outer chamber 239. A same though opposite magnetic force, illustrated at the start of a cycle as a positive (+) magnetic force, is exerted onto the outer wall 235 and inner wall 234 of the inner chamber 238, and more specifically is exerted to respective magnetizable contacts (not shown) on the outer wall 235 and the inner wall 234 of the inner chamber 238. The magnetic force applied to the inner and outer walls 236,237 of the outer chamber 239 is alternated from a negative (−) magnetic polarity as shown in FIG. 7, to a positive (+) magnetic polarity, while simultaneously the magnetic force applied to the inner and outer walls 234,235 of the inner chamber 238 is alternated from a positive (+) magnetic force as shown in FIG. 7, to a negative (−) magnetic force. The mass bodies of the plurality of propulsion units 220 reciprocate between their respective first and second ends of the axles, as had been described in detail hereinabove, generating folded acceleration of the mass bodies while avoiding vibration upon the vehicle 210.

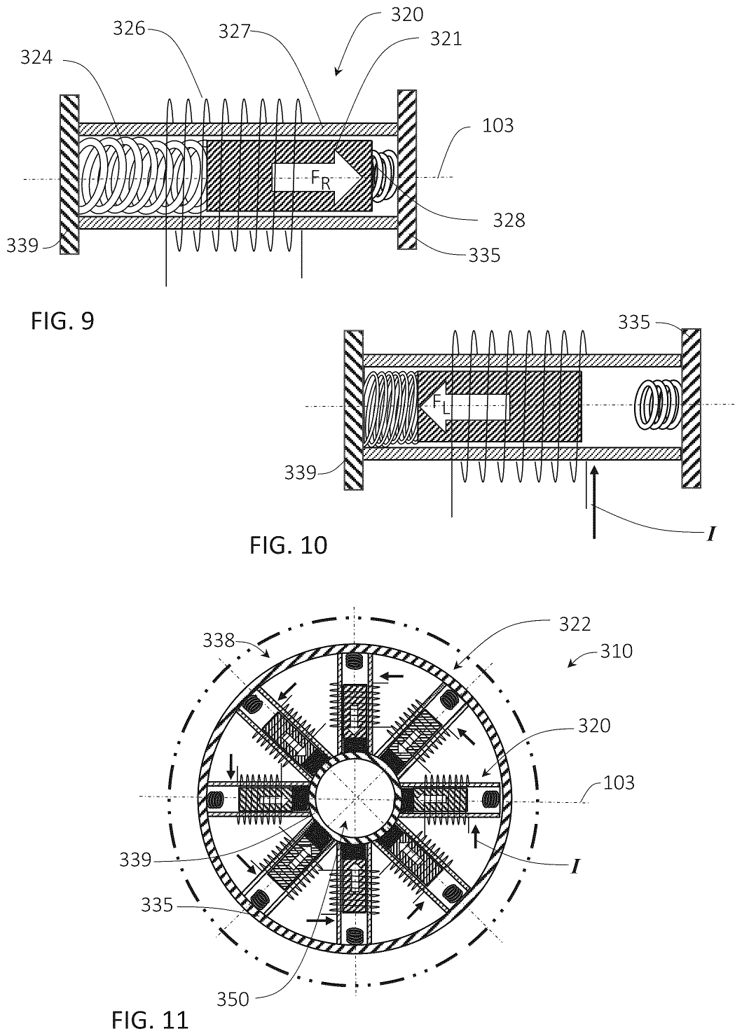

FIGS. 9 and 10 illustrate another embodiment of a propulsion unit, illustrated as a solenoid propulsion unit 320. Each solenoid propulsion unit 320 has a mass body, referred to as a mass plunger 321 moving reciprocally along an axis 103 within a solenoid housing 327, with minimal friction or frictionlessly. The mass plungers 321 have a cylindrical shape of a solid mass, typically symmetrically around its axis, and are typically made of a ferromagnetic material such as iron, though other materials can be nickel, cobalt, and alloys thereof. The mass plungers 321 are driven axially using an electrical solenoid coil 326 that exerts a magnetic field in response to the passage of an electric current I (FIG. 10) through the coiled conducting wire of the electrical solenoid coil 326.

A movement cycle of a solenoid propulsion unit 320 is illustrated starting in FIG. 9, A proximal force element, illustrated as a return spring 324 is positioned against a proximal wall 339 at the proximal end of the solenoid housing 327. The return spring 324 has exerted a compression force (white arrow) upon the proximal end of the mass plunger 321, and has driven the mass plunger 321 to the distal end of the solenoid housing 327. A dampening spring 328, positioned against a distal wall 335 at the distal end (to the right) of the solenoid housing 327, can engage the distal end of the mass plunger 321, to slow or deaden the mass plunger 321 approaching the distal end of the solenoid housing 327.

At or proximate the moment that the mass plunger 321 comes to a nonmoving state and a stationary position at the distal (right) end of the solenoid housing 327, the electrical current I is passed through the coiled conducting wire of the electrical solenoid coil 326, which generates a strong magnetic field that forces the ferromagnetic mass plunger 321 to move axially toward the proximal end (to the left) of the solenoid housing 327 (which does generate a change in momentum of the mass plunger 321 that contributes a portion of the force F_{R} illustrated in FIG. 9). The mass plunger 321 moves toward the proximal (left) end, and engages and compresses the return spring 324. As the proximal end of the mass plunger 321 approaches the proximal end of the solenoid housing 327, as shown in FIG. 10, the return spring 324 has become fully compressed, generating a portion of the force F_{L}. The electrical current I is then cut off, and in the absence of magnetic field on the mass plunger, the compressed return spring 324 releases its compression force and drives the mass plunger 321 back towards the distal (right) end of the solenoid housing 327, generating a remaining portion of the force F_{L}, completing a solenoid cycle, as shown again in FIG. 9.

A next solenoid cycle begins by resending the electrical current I to the coiled conducting wire of the electrical solenoid coil 326.

FIG. 11 illustrates a vehicle 310 that includes an engine chamber 338 and a cabin space 350, the engine chamber 338 housing a FAPS 322 that includes a plurality of solenoid propulsion units 320, with the plurality of solenoid propulsion units 320 arranged in a circular pattern in a common plane with the plurality of mass plungers 321 reciprocating radially from a center point of the FAPS 322. The engine chamber 338 typically maintains an evacuated space or vacuum about the plurality of propulsion units 320.

The FAPS 322 includes an outer chamber wall 335 and an inner chamber wall 339. The opposed ends of the plurality of solenoid housing 327 extend between and are secured with, directly or indirectly, the outer chamber wall 335 and an inner chamber wall 339.

The solenoid propulsion units 320 are positioned symmetrically to provide equal angular separation from one another. The solenoid cycles of the plurality of solenoid propulsion unit 320 are perfectly synchronized to reciprocate radially outwardly and inwardly for a multitude of cycles, at very rapid acceleration and velocity, and very short cycle times, to generate folded acceleration with no net vibration force on the FAPS 322 or the vehicle 310.

While the illustrated embodiment shows eight (8) solenoid propulsion units 320, a significantly larger number of propulsion engines can be incorporated into the engine chamber 338. And while only a single grouping of eight solenoid propulsion units 320 are illustrated, larger numbers of solenoid propulsion units can be grouped, and multiple rings consisting of multiple solenoid propulsion units can be used, provided that the plurality of propulsion units 320 are oriented symmetrically, so that any forces generated by the movement of a mass plungers 321 offset one another, thereby avoiding vibration of the FAPS 322 upon the vehicle 110.

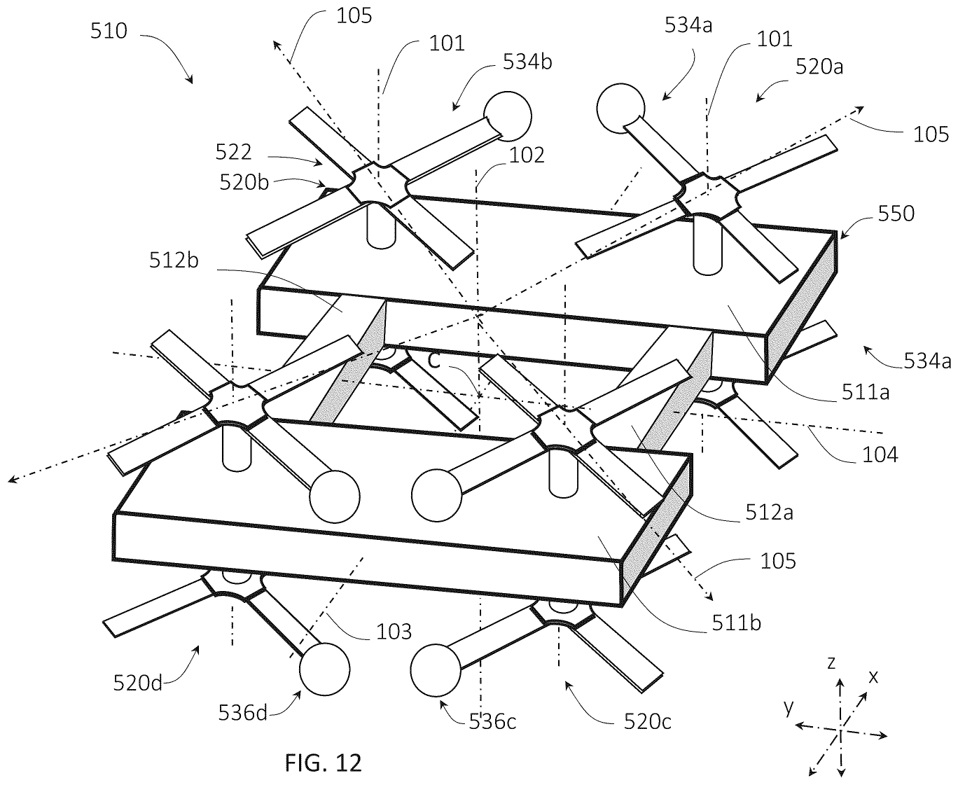

FIG. 12 illustrates another embodiment of a FAPS that provides folded acceleration in a gravitational field, employing rotational (spinning) mass elements. A vehicle 510 includes a FAPS 522 and one or more vehicle bodies 550, including a pair of spaced apart main vehicle bodies 551 and a pair of transverse vehicle bodies 512 that are secured to the main vehicle bodies to provide structure and stability to the vehicle 510 and the FAPS 522. The FAPS 522 includes a plurality of propulsion units 520, each spaced symmetrically apart from the others. In the illustrate embodiment, there are four propulsion units 520a-520d, each disposed for rotation around a vertical axis 101. The plurality of propulsion units 520 are spaced apart a same distance from a vertical line 102 passing through the center of mass C of the vehicle body 510, which is illustrated as the intersections of orthogonal lines 102 (z-direction), 103 (x-direction) and 104 (y-direction).

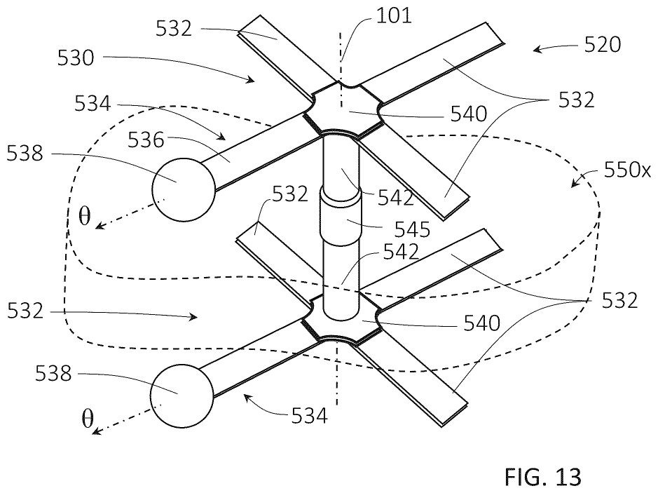

Each propulsion unit 520, illustrated in FIG. 13, has an upper propeller assembly 530 and a lower propeller assembly 532. Typically the upper and lower propeller assemblies are identical in configuration, dimension and construction, and spaced apart a same distance from a horizontal plane passing the center of mass C of the vehicle body 510 oriented through orthogonal lines 103 and 104,

Each propeller assembly 530,532 includes one or more, and preferably a plurality of, blade members arranged, symmetrically or asymmetrically, within a plane around the axis 101, and attached at a proximal end to a hub 540. The plurality of blade members are illustrated as three propeller blade members 532, each identical in configuration, dimension and construction, and a fourth blade member 534 having a high-mass element 535 to the tip (distal end) of a blade 536, typically in the shape of an aerodynamic object, such as a sphere or a streamline (Persu) shape. The three propeller blade members 532 are typically configured to provide vertical lift in an atmosphere, and can be helicopter blades. The fourth blade members 534 of the respective propeller assemblies 530,532, having a high-mass element 538, have an axis oriented in the same radial direction, illustrated in FIG. 13 as radial direction theta (θ). The high-mass elements 538 are oriented in the same radial direction θ. The upper and lower propeller assemblies 530,532 are also spaced at the same distance (z-direction) from the horizontal plane through the center of mass C of the vehicle body 510.

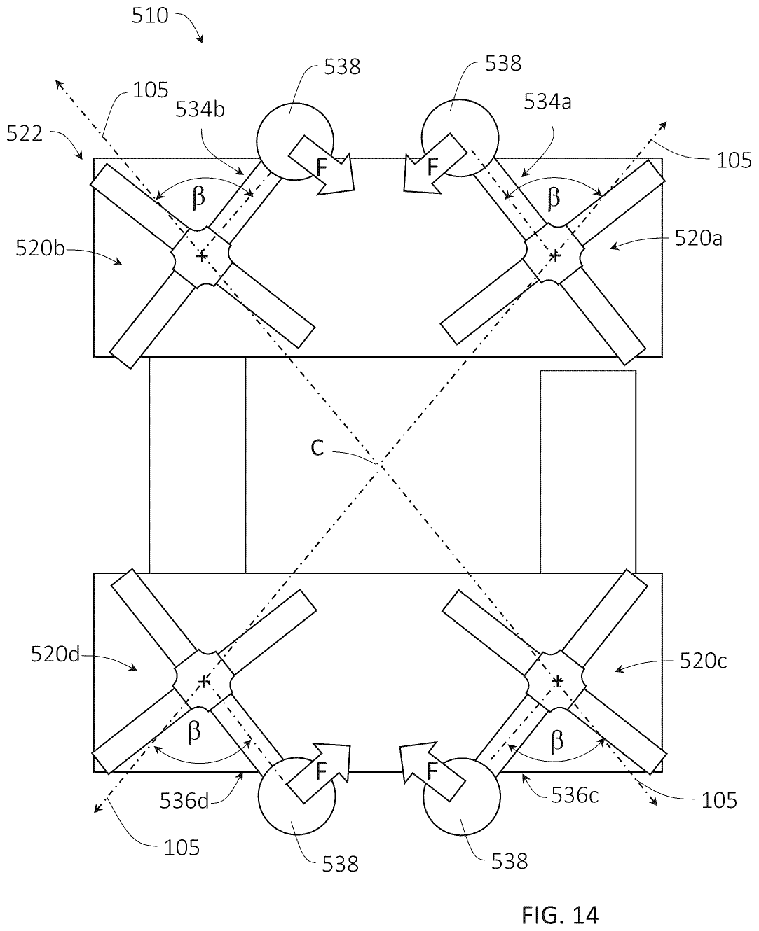

As shown in FIG. 14, the FAPS 522 of the vehicle 510 is configured with the four propulsion units 520a-520d positioned equidistantly from the center of mass C of the vehicle body 510. Each propulsion unit 520 (for example, propulsion unit 520a) is configured to rotate in the same rotational direction (clockwise or counterclockwise) and at the same rotational speed as an opposite propulsion unit (for example, propulsion unit 520d), and in the opposite rotational direction of and at the same rotational speed as the adjacent propulsion units (for example, propulsion units 520b and 520c). The high-mass elements 538 of the propulsion units 520 are oriented at the same radial direction beta (β) from the axial lines 105 passing from the center of mass C and through the centerlines 101 of each propulsion unit 520. The upper and lower propeller assemblies 530,532 are also spaced at the same distance (z-direction) from the horizontal plane through the center of mass C of the vehicle body 510.

The combination of the above features of the propulsion units 520, which include the orientation of the high-mass elements 538 in the same radial direction θ, the spacing of the upper and lower propeller assemblies 530,532 the same distance from the horizontal plane through the center of mass C of the vehicle body 510, the relative rotational direction of the propulsion units 520, and the orientation of the high-mass elements 538 in the same radial direction β from the axial lines 105, results in a balancing of the forces acting on the vehicle body 510 during operation (rotation) of the propulsion units 520 that prevents vibration and maintains the position of the vehicle body 510.

The preceding description provides the basic mechanical elements necessary for a vehicle to employ folded acceleration. A more detailed description of folded acceleration and its principles will now be presented.

The following description illustrates the use of folded acceleration using a single folded acceleration propulsion engine 422 to increase altitude for an orbital vehicle, such as the ISS, without using any ejected propellant.

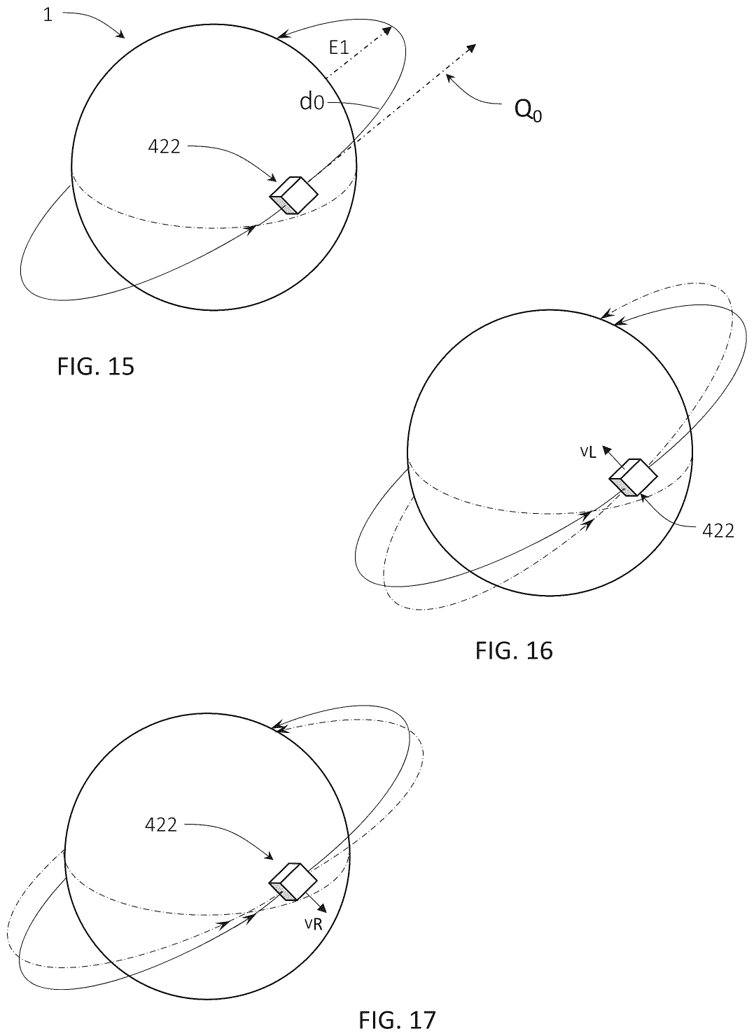

Consider the folded acceleration propulsion engine (hereinafter FAPE) 422 illustrated in FIGS. 15-17. FIG. 15 (not to scale) shows a FAPE 422 in a stable orbit around a planet 1, for example Earth. In this embodiment, the propulsion element uses a self-contained, non-ejectable propulsion mechanism, that does not require any physical propellant to be ejected or expelled from the vehicle in which the propulsion element is employed. The non-ejectable propulsion system, which can be an electromagnetic, or electromechanical, or mechanical propulsion system, to exert an alternating, opposing force upon the FAPE 422. to achieve the zig-zag pattern along the alternating, periodic, left-and-right directional vectors Qₙ at the increased absolute linear velocity of V_{N}. The non-ejectable propulsion system passes a non-electable propellant mass laterally, or left and right, within the internal or attached environment of the satellite.

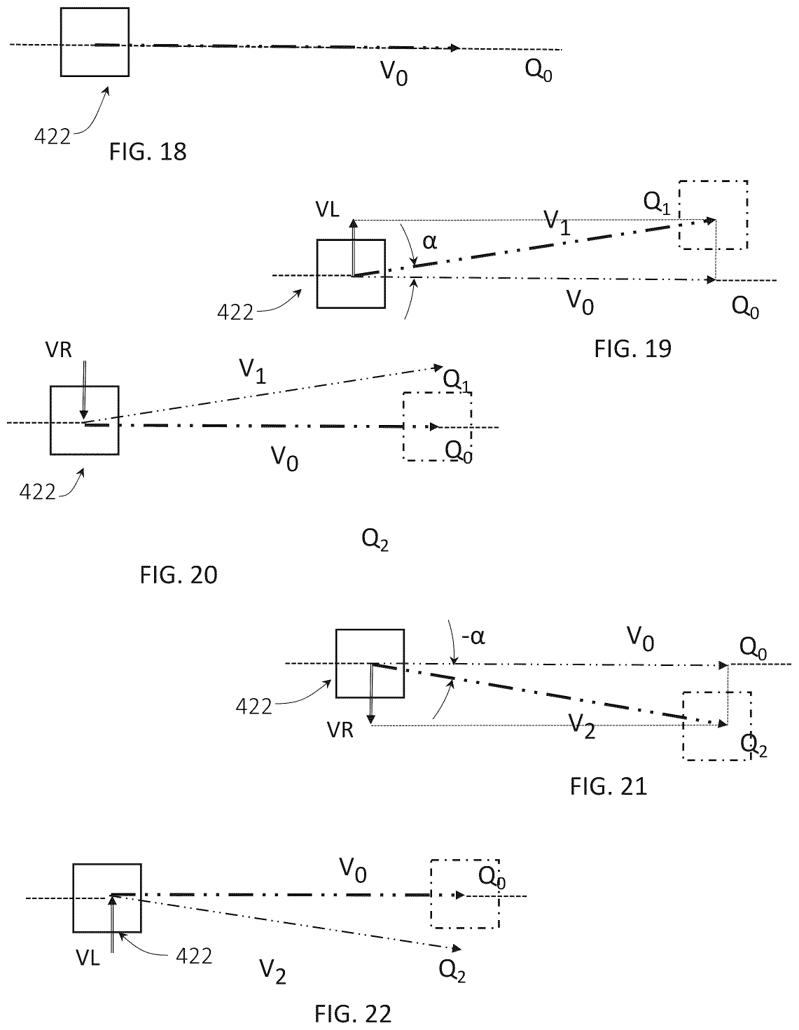

The FAPE 422 is initially moving in an orbit do along in a direction vector Q₀ at an initial linear (tangential) velocity V₀, at an initial satellite elevation E1, as illustrated in FIG. 15 and shown in the schematic of FIG. 18.

In a conventional propulsion system, a propellant can be released in any of the six possible directions: left, right, back, forward, up, and down. If we need to increase the speed or to increase the altitude and achieve maximum efficiency we would release the propellant backward, downward, or a combination of both.

In an illustration of the present invention, however, a “propellant” amount (an object with mass) is pushed laterally (equivalent to ejecting propellant laterally), either left or right. Pushing the same object with mass on the right side (equivalent to releasing propellant to the right side) will add a tangential velocity component on the left direction (velocity V_{L}), which causes the satellite to move in a new direction vector Q₁ different than, and deviating by a direction angle alpha (α) from, the original direction vector Q₀, and at an increased linear velocity V₁, as illustrated in FIG. 16 and shown in the schematic of FIG. 19. The FAPE 422 is now traveling faster (tangential velocity V₁) and in a different trajectory and the orbit has changed.

To bring the FAPE, back to the initial flight path, the same object with mass is now pushed back on the left side (equivalent to releasing propellant to the left side), which will add a tangential velocity component on the tight direction (velocity V_{R}), which causes the satellite to move in a new direction vector Q₂ and increased tangential velocity, and back along the original direction vector Q₀, and back to the initial linear velocity V₀, as shown in the schematic of FIG. 20. Pushing for the third time the same object with mass on the left side again will (again) add a velocity component (V_{R}) in the right direction which now causes the satellite to move in a direction vector Q₂ and increased tangential velocity different than, and deviating by a direction angle minus alpha (−α) from, the original direction vector Q₀, and at an increased linear velocity V₂, as illustrated in FIG. 17 and shown in the schematic of FIG. 21. To bring the satellite back to the initial flight path, the same object with mass is now pushed for the fourth time on the right side with a velocity component on the left direction (velocity V_{L}), which causes the FAPE 422 to move back along the original direction vector Q₀, and back to the initial linear velocity V₀, as shown in the schematic of FIG. 22. Since the same object with mass was pushed to the left and right sides and with the same frequency from one propulsion to the next, the FAPE 422 returns to the same original direction vector Q₀ and the same initial linear velocity V₀, as shown in the schematics of FIGS. 15 and 19. However, during time periods when the FAPE 422 is accelerating left and right, there is an increased velocity V₁ and velocity V₂ compared to initial velocity V₀. The result is that the absolute average linear velocity of the FAPE 422 increases, effecting an increase in the altitude of the orbit of the FAPE 422, by a small or very small, and by a non-zero, amount. Cyclically pushing left/right an object with mass (acting as a recoverable “propellant”) has the final effect of forcing the satellite to cyclically deviate right/left from the straight flight path. While the instant trajectory seems to be changed, the mean trajectory path remains identical, the satellite is just oscillating left/right on the same trajectory, hence it has increased absolute speed.

In an alternative embodiment, after having pushing an object with mass on the right side and achieving the direction vector Q₁ and increased linear velocity V₁, as shown in the schematic of FIG. 20, a series of alternating pushes of the object with mass in the same frequency, starting on the left side and then to the right side, causes the FAPE 422 to move to the direction vector Q₂ with linear velocity V₂, as shown in the schematic of FIG. 22, and then back to the direction vector Q₁ with linear velocity V₁, as shown in the schematic of FIG. 19, and back and forth, over and over, again and again. With each cycle or object with mass push (the recoverable/reusable “propellant”), the FAPE 422 achieves the higher linear velocity V₁ or V₂ as compared to the initial linear velocity V₀, and while maintaining the same general original direction vector Q₀ and same initial linear velocity V₀ along the same original orbital path, the average linear velocity of the FAPE 422 along the alternating direction vectors Q₁ and Q₂ have increased respectively to linear velocity V₁ and linear velocity V₂. Again, each segment of increased linear velocity V₁ and V₂ results in an increase in altitude toward a second satellite elevation E2.

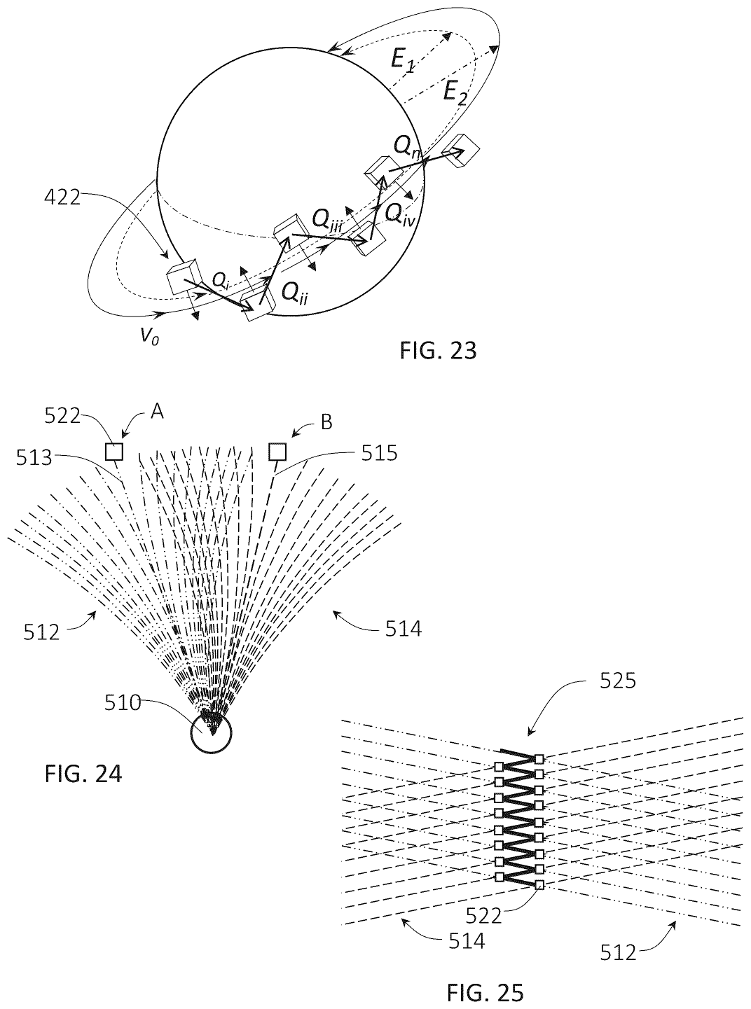

As shown in FIG. 23, although the FAPE 322 travels along the initial orbit d₀ in the direction vector Q₀ at the same initial linear velocity V₀ and at an initial satellite elevation E1, the FAPE 422 travels in a zig-zag (sine-wave) pattern along the alternating, periodic, left-and-right directional vectors Qᵢ through Qₙ at an increased absolute linear velocity (V_{N}). The increased absolute linear velocity (V_{N}) increases the altitude of the satellite to the second satellite elevation E2, resulting from the higher centrifugal force of the increased absolute linear velocity of the satellite.

The present invention utilizes the principle of folded acceleration delivered by a folded acceleration propulsion engine (hereinafter FAPE) to increase orbital altitude of a vehicle having a one or more, and typically a multiplicity of, propulsion units and/or propulsion engines, employing a non-ejectable propellant, to raise the altitude of the vehicle as it travels in a stable orbit around a planet, or in space in the gravitational fields of a multiplicity of celestial bodies.

In various embodiments, a source of power to drive the mass bodies and/or generate magnetic charges is typically selected to provide an efficient conversion of energy generated to centrifugal force. Non-limiting examples of power sources can include nuclear, thermal, acoustic, electromagnetic, solar and other optical, and chemical sources.

Another embodiment of a RAPS that can provide folded acceleration in a gravitational field, employs electromagnetic/microwave polarized vibration of mass particles embedded in the interior/exterior wall paint. Any gaseous, liquid, plasma or other sub-atomic particles with mass physically confined in the proximity of the exterior or interior walls of a spacecraft could be used for this embodiment, either embedded in the walls (in the paint) or confined in special propulsion chambers. All these particles with mass will be driven in a controlled manner through polarized. electromagnetic energy in order to employ the Folded Acceleration technique. The most common implementation would be to drive the mass through electric power converters capable to generate necessary high frequency alternating currents with proper polarity and phase. The folded acceleration propulsion engine (hereinafter FAPE) can have any physical shape, and any existing spacecraft could be retrofitted with a special paint and power converters to activate and use the mass embedded in the interior/exterior paint or the mass confined in special propulsion chambers. Non-limiting examples of a shape of the FAPE can include a sphere, an ovoid, and a streamline Persil. Or, even the walls of the whole spacecraft can be directly driven with electromagnetic/microwave energy, there is enough microscopic elasticity to allow for high-frequency polarized vibration to achieve the Folded Acceleration effect. The Folded Acceleration effect can be achieved equally over gigantic distances in space with very low frequency, or over microscopic and sub-atomic distances with high frequency, it works the same: the Folded Acceleration effect is scalable in both space (from light years to sub-atomic distance) and time (from billions of years to femtoseconds).

### Stable Orbital Flight Calculation

To further illustrate the concept of folded acceleration, we will first describe some basic principles and their calculation for a vehicle (VEH) (which will use as an example the International Space Station or ISS) that travels is a stable orbit of a radius R_{ISS} about the Earth travels at a velocity of about 7.67 kilometers per second (km/s) in order to exert a centrifugal force equal to the gravitation force of the Earth on the ISS. In this case, the ISS has a mass, and M_{VEH} equals M_{ISS}, though any satellite or vessel of any mass needs to travel at the same velocity of about 7.67 km/s. We can determine the centrifugal force itself with the equation:

F_{CENT}=(M_{VEH})×(V_{ISS})²/R_{ISS}, (1)

In a first hypothetical example, assume for a moment that the ISS is at the orbital altitude, but is traveling at zero velocity, but instantaneously, a mass of propellant is ejected from the ISS rearwardly, opposite of the intended orbital path. This can be illustrated as the launching of ISS from a static point (or platform) at the intended orbital altitude. In order to instantaneously propel the ISS into its stable orbit velocity (V_{ISS}) of about 7.67 km/s, an ejected propellant of some mass (M_{PROP-E}) must be emitted instantaneously at a velocity V_{PROP-E} that provides a force equal to (and in the opposite direction of) the centrifugal force of the ISS vehicle, to instantaneously achieve the stable orbital velocity. The equal forces of the emitted propellant F_{PROP-E} and the orbiting ISS are written as:

(M_{VEH})×(V_{VEH})²/R_{ISS}=M_{PROP-E}×(V_{PROP-E})²/R_{PROP-E}, (2)

where R_{VEH}=R_{PROP-E}, the equation can be solved for the velocity of the propellant as:

V_{PROP-E}=V_{VEH}×sqrt(M_{VEH}/M_{PROP-E})=V_{VEH}×sqrt(k), (3)

where k is the ratio of the mass of the vehicle (ISS) to the mass of the instantaneously-ejected propellant. In this scenario, the mass of the vehicle is just the mass of the ISS itself, since the entire mass of the ejected propellant is instantaneously ejected from the ISS. If the mass of the instantaneously-emitted propellant (M_{PROP-E}) will be equal to the M_{VEH} (or M_{ISS}), then k=1, and the instantaneously-emitted propellant must be emitted at the orbital velocity of the ISS, or about 7.67 km/s. The smaller the mass M_{PROP-E} of the ejected propellant, the faster the velocity of the ejected propellant, V_{PROP-E}.

In a second hypothetical example, similar to the first hypothetical example, but in this case the propellant is retained on-board the ISS vehicle, such that the mass of the vehicle (M_{VEH}) equals the mass of the ISS itself (M_{ISS}), plus the mass of the on-board propellant, M_{PROP-OB}, that is not ejected as a mass from the vehicle. In this example, the on-board propellant is a propellant engine system that exerts a folded acceleration within the confines of the vehicle itself. In this example, k is the ratio of the mass of the vehicle (M_{VEH}), consisting of the sum of the mass of the ISS (M_{ISS}) and the mass of the propellant engine on-board propellant engine (M_{PROP-OB}), to the mass of the on-board propellant engine (M_{PROP-OB}),

$$\begin{matrix}{V}_{PROP - OB} = {V}_{VEH} \times sqrt ( ( {M}_{ISS} + {M}_{PROP - OB} ) / {M}_{PROP - OB} ) \\ = {V}_{VEH} sqrt ( k )\end{matrix} . \qquad ( 4 )$$

In order to instantaneously propel the ISS into its stable orbit velocity (V_{ISS}) of about 7.67 km/s using an on-board propellant engine of the same mass as the ISS, the factor k is equal to 2, sqrt(k) is about 1.414, the velocity of the on-board propulsion engine must oscillate (or reciprocate at an average velocity) is about 7.67 km/s×1.414, or about 10.81 km/s.

In this illustration, the “mass of the on-board propellant, M_{PROP-OB}” is the sum of masses of all the plurality, or multiplicity, of mass bodies that constitute the propulsion engine, and the “mass of the vehicle (M_{VEH})” includes the mass of any containment structure(s), magnetic charge contacts, axles, resilient (spring) members, etc. necessary to move the mass bodies, in addition to the vehicle itself In this scenario, each one of the mass objects of the vehicle would need to move (accelerate and decelerate) at an average velocity of about 10.81 km/s.

In a third hypothetical example, similar to the second hypothetical example, the ISS with the on-board propellant engine is already in a stable orbit around the Earth. In this scenario, we are concerned with a means for increasing the orbital altitude using the on-board propulsion engine as described herein. In this example, the ISS is orbiting at an assumed tangential velocity of 7,670 km/s at an altitude of 415 km about the surface of the Earth, which surface has a radius of about 6371 km, and thus orbiting at an absolute altitude of 6786 km. Each orbit of the ISS takes about 5,556.2 seconds.

Once in a stable orbit at a stable altitude, any increase in the tangential velocity of the ISS will increase its centrifugal force, and thereby raise its orbital altitude. In a non-limiting example, if the speed of the ISS could be increased by 1 meter per second (1 m/s), the altitude of the ISS can be increased by 0.058 m/orbital, or 0.899 m/day, or 328.18 m/year.

In this illustration, again where the “mass of the on-board propellant, M_{PROP-OB}” is the sum of masses of all the plurality, or multiplicity, of mass bodies that constitute the propulsion engine, and the “mass of the vehicle (M_{VEH})” includes the mass of any containment structure(s), magnetic charge contacts, axles, resilient (spring) members, etc. necessary to move the mass bodies, in addition to the vehicle itself, each one of the mass objects of the vehicle would only need to move (accelerate and decelerate) at an average velocity of about 1 m/s, which is well within the mechanical capabilities of modern mechanical technology, including but not limited to the propulsion engines and systems described herein.

While mass bodies of a very large size in mass can be reciprocated at an average speed of 1 m/s, the same centrifugal force effect can be achieved with a very small mass that is moved at an extremely high speed, such as polarized high frequency electromagnetic oscillations.

A system for providing folded acceleration will seek to optimize the two factors of total mass and frequency of cyclic movement, which for a fixed pathway is the determining feature of the acceleration and speed of the mass.

Consequently, once a vehicle has been placed into a stable orbit around a planet, such as Earth, a folded acceleration propulsion system employing a non-ejectable propellant could be used to maintain the stable orbit of the vehicle indefinitely, or to adjust its altitude, and even propel the vehicle beyond a gravitational orbit and into space, without the necessity of a conventional ejected propellant.

### Gravity Well Ladder and Deep Space

To aid in an understanding of folded acceleration and the movement of a propulsion engine through deep space, an illustration is provided of a gravity well ladder and its effect on a folded acceleration propulsion engine (FAPE) moving in deep space, for generating and amplifying local gravity assist. Further details of the principles of gravity potential can be found at http://en.wikipedia.org/wiki/gravitational_potential, the disclosure of which is incorporated by reference in its entirety. Further details of field lines and force fields can be found at http://en.wikipedia.org/wiki/field_line and http://en.wikipedia.org/wiki/force_field_(physics), respectively, the disclosures of which are incorporated by reference in their entireties. Further details of the principles of gravity assist can be found at http://en.wikipedia.org,/wiki/gravity_assist, the disclosure of which is incorporated by reference in its entirety.

The gravity well ladder illustrated in FIG. 24 shows a spacecraft vessel 510 powered by a folded acceleration propulsion engine moving from a position A in space to a position B, in the vicinity of a celestial body 500. The gravity field lines 512 directed toward the vicinity of position A in deep space, and the gravity field lines 514 directed toward the vicinity of position B in deep space, are vertical and directly along respective vector lines 513 and 515 when closer to the celestial body 500, but are curved and deviate at a steepening angle along at farther distances from the celestial body 500. Consequently, for the spacecraft vessel 510 very far away from the celestial body 500, the respective gravity lines 512 and 514 deviate or bend toward an angle transverse to the respective vector lines 513 and 515. It can also be seen that at positions between positions A and B, the gravity lines 512 and the gravity lines 514 intersect at an angle.

From position A, accelerating the mass of the FAPE to the right will force the vessel 510 to move upward on the gravity field lines 512, trying to cross them (centrifugal force, pushing against the gravity field lines 512). Deaccelerating and stopping acceleration of the mass of the FAPE occurs when the vessel 510 approaches position B. Then accelerating the mass of the FAPE, to the left will force the vessel 510 to move upward on the gravity field lines 514, trying to cross them (centrifugal force, pushing against the gravity field lines 514). Deaccelerating and stopping acceleration of the mass of the FADE occurs when the vessel 510 again approaches position A. Repeating the acceleration and deceleration, right and then left, between the positions A and B, causes the vessel 510 to move, as shown in the zig-zagging black lines 525, upward on the gravity well ladder as it crosses the gravity field lines, along the gravity lines in deep space, far from the celestial body, which are always at an angle though near-horizontal.

Returning to the universe, and the impact and opportunities from the use of the present invention, the Cosmological Constant is a continuous and continuously variable coefficient throughout the whole universe, and can be measured as such in each point of the universe by a device with a folded acceleration engine. By changing the orientation of the folded acceleration engine in the three dimensions (3D) space (for example, using gyroscopic orientation) and measuring the strength of the resulting acceleration (for example, using accelerometer) produced by an engine of the present invention, the Cosmological Constant can be dynamically mapped in 3D, in every point of the universe that can be physically reached. Triple-axial negative feedback loops can be used with folded acceleration propulsion engines capable to real-time map in 3D the local gravity vector (the local Cosmological Constant) and automatically adjust the trajectory of a space vehicle within some limits, always accelerating away from the dominant gravity source (propulsion) or breaking against a gravity source (avoiding collision or crushing).

The disclosures of the following reference are incorporated by reference in their entireties: U.S. Pat. Nos. 8,066,226, 9,527,607, 9,643,739, 10,027,257, 10,486,835, and 10,513,353, US Patent Application Publications 2014/0013724 and 2019/0352022, and PCT Publication WO 2005/016746.

We claim:

1. A method for space propulsion of a vehicle in a gravitational field, useful for altitude control or space travel in deep space of the vehicle, comprising the steps of:
i) providing a vehicle including a propulsion engine comprising one or more non-ejectable propellant masses, the vehicle having a total mass including the one or more non-ejectable propellant masses,
ii) placing the vehicle in a stable orbital altitude at a stable tangential velocity or placing the vehicle in a controlled trajectory is space,
iii) accelerating the one or more propellant masses cyclically in a selected average vectorial direction between two random and distinctive points following any random path with a mean central point, thereby generating and amplifying local gravity assist, and causing the propulsion engine to accelerate the vehicle away from the source of the gravitational field to a tangential velocity that matches a stable tangential velocity to maintain the vehicle in the stable orbital altitude, or exceeds the stable tangential velocity to raise the vehicle to a second stable orbital altitude, or continuously and locally generates gravity assist boost to the vehicle moving through the cosmic gravitational field lines in deep space, or pushes away from and upward against gravity on the gravity well field lines.

2. The method of claim 1 wherein the propulsion engine comprises two or more propulsion units, each propulsion unit comprising one or more non-ejectable propellant masses.

3. The method of claim 2 wherein the selected vectorial direction is along or within a common axle, a common plane, or a full 4π steradian solid angle, the two or more propulsion units configured collectively to cyclically accelerate and deaccelerate equally and oppositely to avoid vibration upon the propulsion engine and the vehicle or moves through Folded Acceleration between two random and distinctive points following any random path with a mean central point.

4. The method of claim 3 wherein one or more non-ejectable propellant masses reciprocate along a linear pathway.

5. The method of claim 4 wherein the one or more non-ejectable propellant masses can comprise a mass selected from the group consisting of gaseous, liquid, plasma, solid and quantum particles, and a combination thereof.

6. The method of claim 5 wherein the propulsion engine includes one or more motion and force generating elements to accelerate the one or more non-ejectable propellant masses.

7. The method of claim 6 wherein the propelling forces includes a non-ejectable propulsion means selected from the group consisting of an electromagnetic, an electromechanical, a mechanical propulsion system, and a combination thereof.

8. The method of claim 3 wherein each of the one or more non-ejectable propellant masses rotates around an axis or moves through Folded Acceleration between two random and distinctive points following any random path with a mean central point.

9. The method of claim 8 wherein the axis of rotation of the one or more non-ejectable propellant masses do not pass through the center of mass of the vehicle.

10. The method of claim 9 wherein the one or more non-ejectable propellant masses can comprise a mass selected from the group consisting of gaseous, liquid, plasma, solid and quantum particles, and a combination thereof and moves through Folded Acceleration between two random and distinctive points following any random path with a mean central point.

11. The method of claim 10 wherein the propulsion engine includes one or more motion and force generating elements to accelerate the one or more non-ejectable propellant masses.

12. The method of claim 11 wherein the propelling forces includes a non-ejectable propulsion means selected from the group consisting of an electromagnetic, an electromechanical, a mechanical propulsion system, and a combination thereof.

13. A method for adjusting the orbital altitude of a vehicle in a gravitational field, useful for vehicle altitude control, comprising the steps of:
iv) providing a vehicle including a propulsion engine comprising one or more non-ejectable propellant masses, the vehicle having a total mass including the one or more non-ejectable propellant masses,
v) placing the vehicle in a stable orbital altitude at a stable tangential velocity,
vi) accelerating the one or more propellant masses cyclically in a selected vectorial direction, which generates a centrifugal acceleration, and causes the propulsion engine to accelerate the vehicle away from the source of the gravitational field to a tangential velocity that matches the stable tangential velocity to maintain the vehicle in the stable orbital altitude, or exceeds the stable tangential velocity to raise the vehicle to a second stable orbital altitude.

14. The method of claim 13 wherein the propulsion engine comprises two or more propulsion units, each propulsion unit comprising one or more non-ejectable propellant masses.

15. The method of claim 14 wherein the selected vectorial direction is along or within a common axle, a common plane, or a full 4π steradian solid angle, the two or more propulsion units configured collectively to cyclically accelerate and deaccelerate equally and oppositely to avoid vibration upon the propulsion engine and the vehicle.

16. The method of claim 15 wherein one or more non-ejectable propellant masses reciprocate along a linear pathway, and the one or more non-ejectable propellant masses can comprise a mass selected from the group consisting of gaseous, liquid, plasma, solid and quantum particles, and a combination thereof.

17. The method of claim 16 wherein the propulsion engine includes one or more motion and force generating elements to accelerate the one or more non-ejectable propellant masses, wherein the propelling force includes a non-ejectable propulsion means selected from the group consisting of an electromagnetic, an electromechanical, a mechanical propulsion system, and a combination thereof.

18. The method of claim 15 wherein each of the one or more non-ejectable propellant masses rotates around an axis.

19. The method of claim 18 wherein the axis of rotation of the one or more non-ejectable propellant masses do not pass through the center of mass of the vehicle, and the one or more non-ejectable propellant masses can comprise a mass selected from the group consisting of gaseous, liquid, plasma, solid and quantum particles, and a combination thereof.

20. The method of claim 19 wherein the propulsion engine includes one or more motion and force generating elements to accelerate the one or more non-ejectable propellant masses, and wherein the propelling force includes a non-ejectable propulsion means selected from the group consisting of an electromagnetic, an electromechanical, a mechanical propulsion system, and a combination thereof.
